(19) United States
(12) Patent Application Publication
(10) Pub. No.: US 2013/0074298 A1
(43) Pub. Date: Mar. 28, 2013

(54) COFFIN

(71) Applicant: Tony MONG, Livingston, NJ (US)

(72) Inventor: Tony MONG, Livingston, NJ (US)

(21) Appl. No.: 13/434,041

(22) Filed: Mar. 29, 2012

(30) Foreign Application Priority Data
Sep. 23, 2011 (TW) 100134405

(51) Int. Cl. A61G 17/00; A61G 17/007

(52) U.S. Cl. 27/3; 27/2

(57) ABSTRACT

A coffin includes a coffin main body; the coffin main body includes an upper frame, a lower frame, a wall and a first cover. The first cover includes a first outward cover and a first cover frame, which is located on the upper frame and connected to the coffin main body. The wall includes two long walls, two short walls, and a bottom wall. The two long walls and two short walls are connected and surround the upper frame and lower frame, and the bottom wall is located on the lower frame, allowing the bottom wall, two long walls and two short walls to form a container. The first outward cover, two long walls, and bottom wall are made of cardboard which is honeycomb cardboard; the first cover frame, the upper frame, and the lower frame are made of wood.

### BACKGROUND OF THE INVENTION

1. Field of the Invention

The present invention relates to a coffin; more particularly, the present invention relates to a coffin made of honeycomb cardboard and wood.

2. Description of the Related Art

Coffins of the prior art are made of wood, but a wooden coffin, which is heavy and expensive, will generate large amounts of exhaust gas during cremation, which may cause air pollution.

Therefore, the cardboard coffin was developed. For example, the coffin disclosed in U.S. Pat. No. 6,018,853 is made entirely of cardboard. However, this kind of coffin must include a special structure for assembly, and the coffin is insufficiently hard; therefore, the coffin may not be sufficiently durable.

Another example is the coffin disclosed in U.S. Pat. No. 5,771,549. The walls of the coffin consist of cardboard or foam, and the inside and outside of the wall are covered with craft paper for decoration. However, the walls are made of a cardboard material that is insufficiently hard; therefore, the cardboard coffin may not be sufficiently durable.

Another example is the coffin disclosed in U.S. Pat. No. 7,263,751. The walls of the coffin are made of cardboard, a light-weight nail is designed to fix the coffin, and a handle is formed on a wall to reduce the elements of the coffin. However, the walls are made of cardboard material which is insufficiently hard, and some elements of the coffin in the prior art are reduced (such as the handle fastened on a wall); therefore, the cardboard coffin may not be sufficiently durable or useful.

Therefore, there is a need to provide a durable and environmentally friendly coffin made of cardboard and wood to solve the disadvantages of the prior art.

### SUMMARY OF THE INVENTION

It is an object of the present invention to provide a light, durable, environmentally friendly, and cost-saving coffin.

To achieve the abovementioned object, the coffin of the present invention comprises a main body; the main body comprises an upper frame, a lower frame, a wall, and a first cover. The first cover, which comprises a first outward cover and a first cover frame, is positioned on the upper frame and connected to the main body. The wall comprises two long walls, two short walls, and a bottom wall. The two long walls and two short walls are connected to and surround the upper frame and lower frame; the bottom wall is positioned on the lower frame, allowing the bottom wall, two long walls, and two short walls to form a container. The first outward cover, two long walls, and the bottom wall are made of cardboard which is honeycomb cardboard; the first cover frame, the upper frame, and the lower frame are made of wood.

### BRIEF DESCRIPTION OF THE DRAWINGS

FIG. 1 illustrates a schematic drawing of the coffin of the embodiment according to the present invention.

FIG. 2 illustrates a schematic drawing of the coffin of the embodiment according to the present invention when the first cover is opened.

FIG. 3 illustrates an exploded perspective view of the first cover of the coffin of the embodiment according to the present invention.

FIG. 4 illustrates an exploded perspective view of the main body of the coffin of the embodiment according to the present invention.

FIG. 5 illustrates a partial cross-sectional drawing of the coffin of the embodiment according to the present invention.

FIG. 6 illustrates a cross-sectional drawing of the coffin of the embodiment according to the present invention.

FIG. 7 illustrates a bottom exploded perspective view of the coffin of the embodiment according to the present invention.

FIG. 8 illustrates a bottom schematic drawing of the coffin of the embodiment according to the present invention.

FIG. 9 illustrates a cross-sectional drawing of the handle set of the embodiment according to the present invention.

### DETAILED DESCRIPTION OF THE PREFERRED EMBODIMENT

These and other objects and advantages of the present invention will become apparent from the following description of the accompanying drawings, which disclose several embodiments of the present invention. It is to be understood that the drawings are to be used for purposes of illustration only, and not as a definition of the invention.

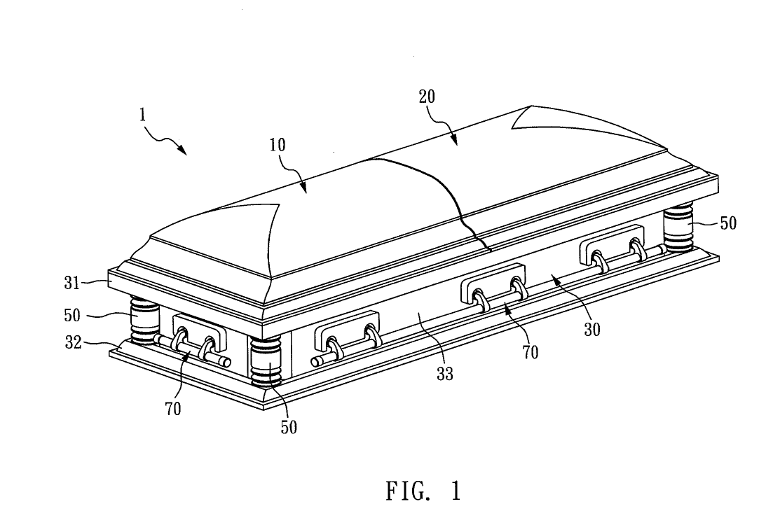

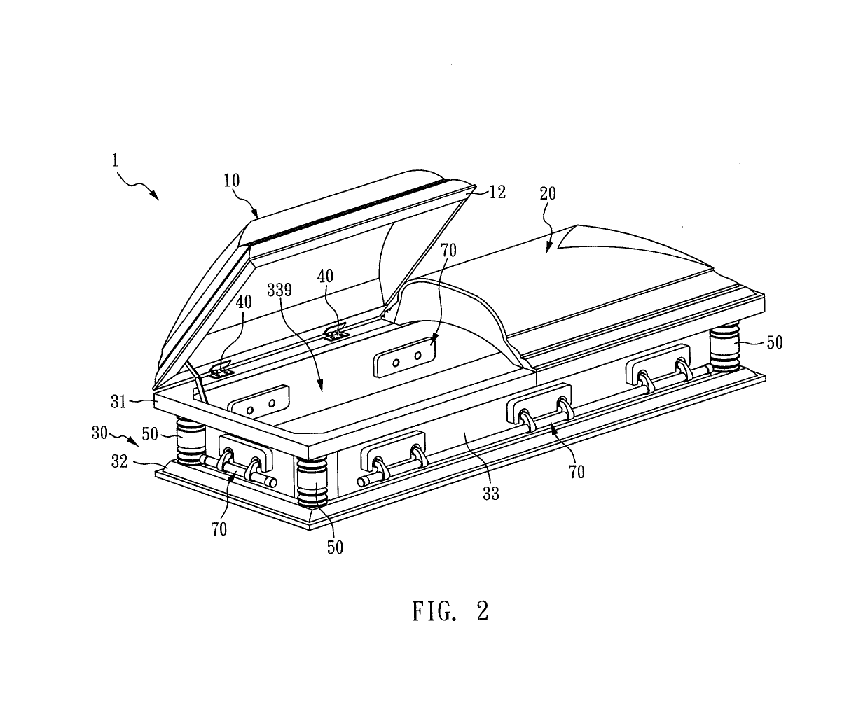

Please refer to FIG. 1 and FIG. 2. FIG. 1 illustrates a schematic drawing of the coffin of the embodiment according to the present invention. FIG. 2 illustrates a schematic drawing of the coffin of the embodiment according to the present invention when the first cover is opened.

As shown in FIG. 1 and FIG. 2, the coffin 1 of the present invention comprises a main body 30, an upper frame 31, a lower frame 32, a wall 33, a first cover 10, a second cover 20, at least two cover connecting parts 40, four decorative columns 50, and four handle sets 70. The wall 33 is connected to the upper frame 31 and the lower frame 32, the upper frame 31 is positioned above the wall 33, and the lower frame 32 is positioned under the wall 33. The first cover 10 and the second cover 20 are positioned above the upper frame 31 and connected respectively to the main body 30 via the at least one cover connecting part 40; the second cover 20 is also positioned next to the first cover 10.

However, the coffin 1 of the present invention is not limited to that design; for example, the coffin 1 can be designed to comprise only one cover instead of two independent covers, which means the second cover 20 of the coffin 1 can be eliminated.

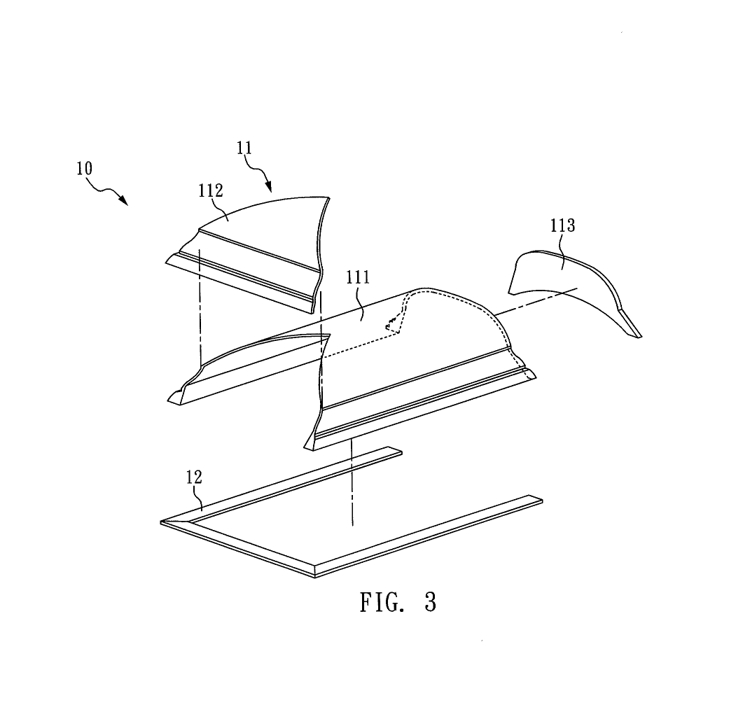

Please refer to FIG. 3, which illustrates an exploded perspective view of the first cover of the coffin of the embodiment according to the present invention.

As shown in FIG. 3, the first cover 10 comprises a first outward cover 11 and a first cover frame 12; the first cover frame 12 is connected to the first outward cover 11 for fastening the first outward cover 11. The first outward cover 11 further comprises a first main cover 111, a first side cover 113, and a first inclined cover 112. The first inclined cover 112 is connected to one side of the first main cover 111; the first side cover 113 is connected to the other side of the first main cover 111 and positioned next to the second cover 20. The first cover frame 12 is made of wood, and the first main cover 111, the first side cover 113, and the first inclined cover 112 are made of cardboard.

However, the first outward cover 11 of the present invention is not limited to that design; for example, the first outward cover 11 can be designed as a flat cover instead of a curved cover, which means that the first cover 11 can omit the first inclined cover 112; or the coffin 1 can be designed as a flat cover instead of two independent covers, which means that the first inclined cover 112 and the first side cover 113 can be omitted in the first cover 11. Furthermore, the material of the first side cover 113 is not limited to cardboard; the material can be thin wood or another similar material.

The structure of the second cover 20 is the same as the first cover 10, so there is no need to describe the structure of the second cover 20 here.

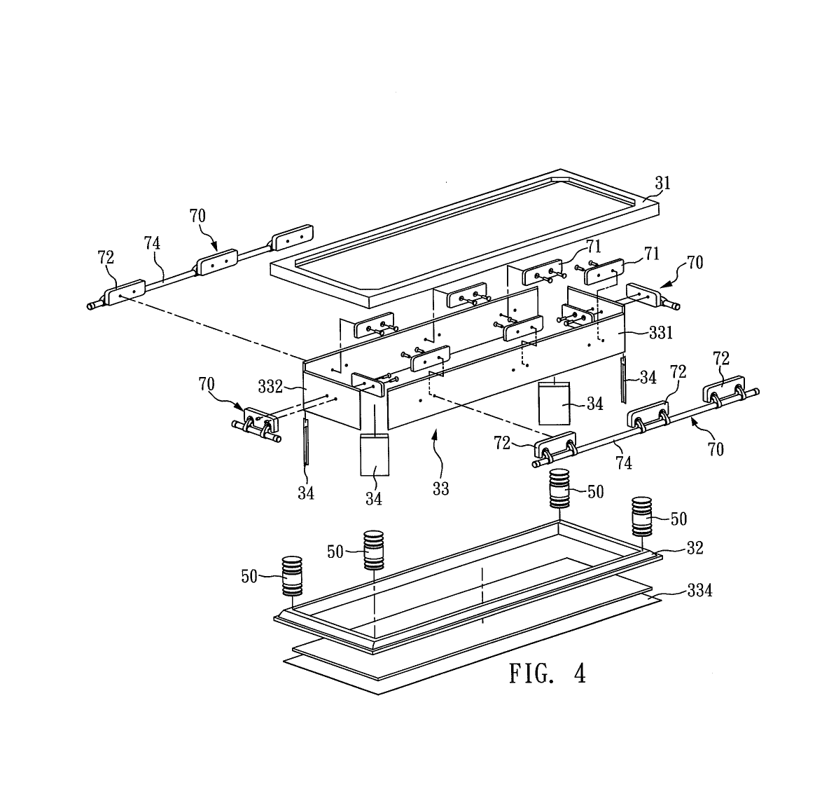

Please refer to FIG. 2 and FIG. 4. FIG. 4 illustrates an exploded perspective view of the main body of the coffin of the embodiment according to the present invention.

As shown in FIG. 2 and FIG. 4, the main body 30 comprises an upper frame 31, a lower frame 32, a wall 33, and four corner walls 34, wherein the wall 33 comprises two long walls 331, two short walls 332, a bottom wall 333, and a bottom decorative wall 334. The long walls 331, the short walls 332, and the corner walls 34 are connected and surround the upper frame 31 and the lower frame 32. The corner walls 34 are positioned between the long wall and the short wall to support the four corners of the main body 30 and to provide better support force. The bottom wall 333, two long walls 331, two short walls 332, and four corner walls 34 form a container 339 for containing a human body.

The long wall 331, the short wall 332, and the bottom wall 333 are made of cardboard; each of the corner walls 34, the upper frame 31, and the lower frame 32 are made of wood, allowing the main body 30 to be more durable. The upper frame 31 and the lower frame 32 are substantially shaped as a rectangular frame; the long wall 331, the short wall 332, and the bottom wall 333 are substantially shaped as rectangular.

However, the present invention is not limited to that abovementioned design. The design of the main body 30 can be changed to meet requirements; for example, the number of the corner walls 34 can be changed, or the corner wall 34, the upper frame 31, and the lower frame 32 can be fixed by nails, allowing the main body 30 to be more durable.

Four decorative columns 50 are respectively positioned outside the four corner walls 34 for decorating the coffin 1; however, the number and the position of the decorative column 50 of the present invention are not limited to that design. The number or the position of the decorative column 50 of the present invention can be changed to meet requirements.

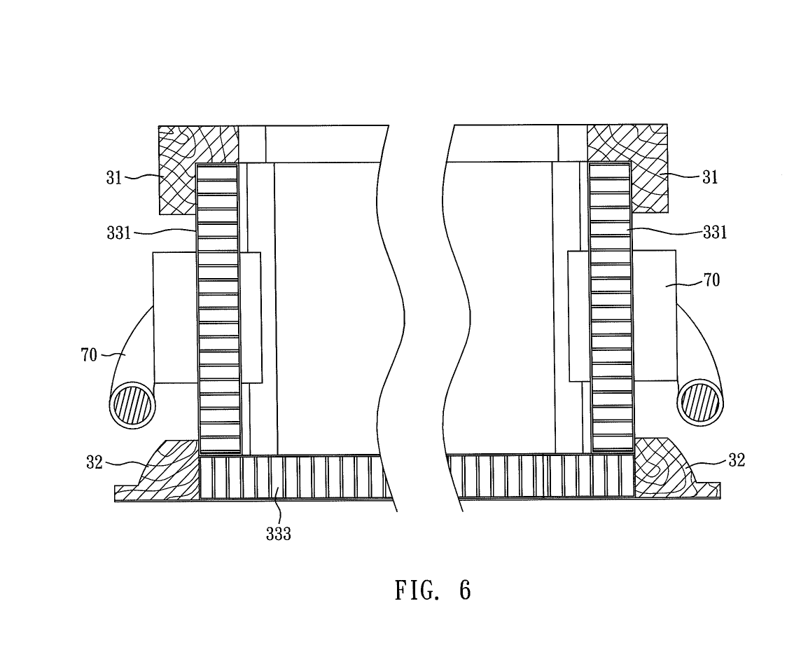

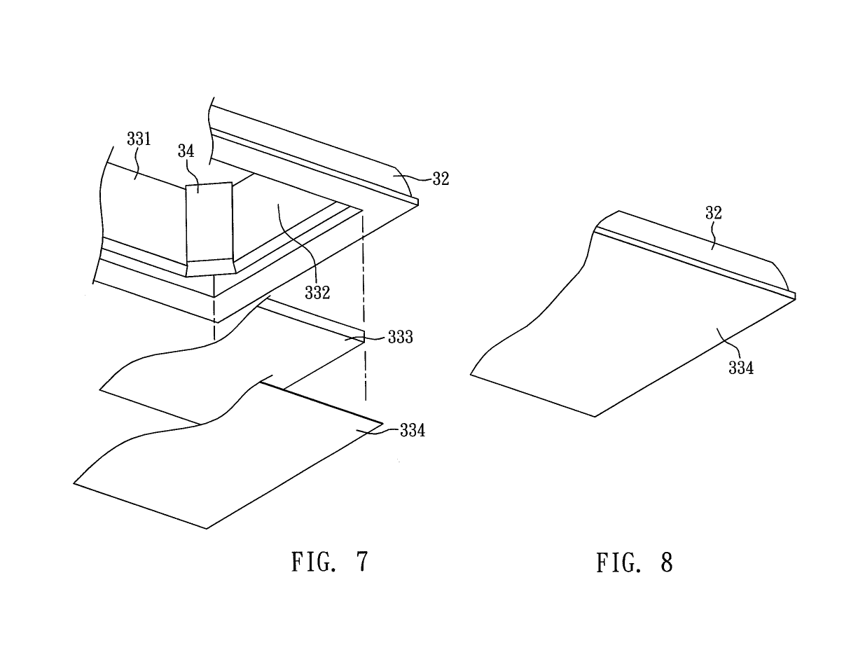

Please refer to FIG. 4, and to FIG. 6 to FIG. 8. FIG. 6 illustrates a cross-sectional drawing of the coffin of the embodiment according to the present invention. FIG. 7 illustrates a bottom exploded perspective view of the coffin of the embodiment according to the present invention. FIG. 8 illustrates a bottom schematic drawing of the coffin of the embodiment according to the present invention.

As shown in FIG. 4, and in FIG. 6 to FIG. 8, the bottom wall 333 is positioned on the position of the lower frame 32, and it is bonded to the long wall 331, the short wall 332, the corner wall 34, and the lower frame 32 via an adhesive in order to increase the support force and the load capacity. Furthermore, a bottom decorative wall 334 is pasted under the bottom wall 333 for decoration. However, the main body 30 of the present invention is not limited to that design; for example, the connecting method for the bottom wall 333 and the lower frame 32 is not limited to bonding. The bottom wall 333 can be nailed onto the lower frame 32 for connecting.

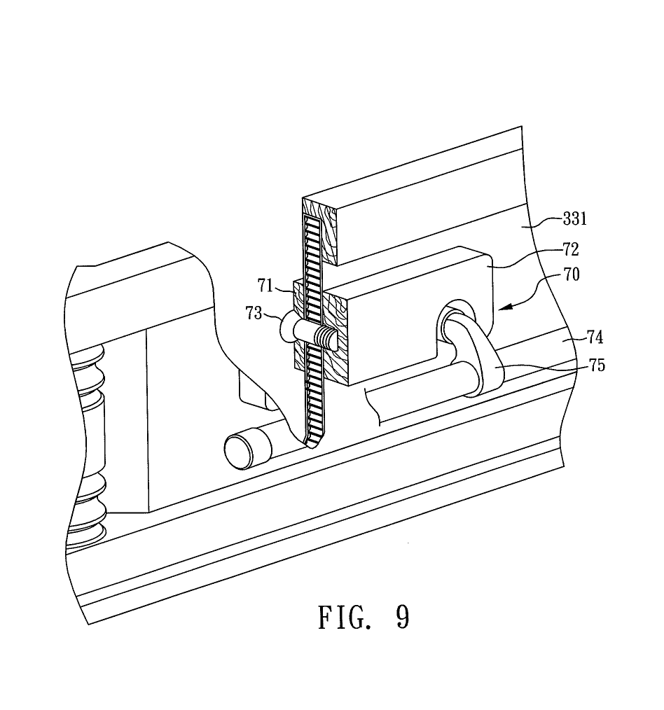

Please refer to FIG. 4 and FIG. 9. FIG. 9 illustrates a cross-sectional drawing of the handle set of the embodiment according to the present invention.

As shown in FIG. 4, two of the handle sets 70 are positioned on the two long walls 331, and the other two handle sets 70 are positioned on the two short walls 332; however, the number and the position of the handle set 70 of the present invention are not limited to that design. The number or the position of the handle set 70 of the present invention can be changed to meet requirements.

As shown in FIG. 9, each of the handle sets 70 comprises at least one inner fixed plate 71, at least one outward fixed plate 72, at least one fastening element 73, at least one handle 74, and at least one holder 75. The handle 74 is connected to the outward fixed plate 72 via the holder 75. The inner fixed plate 71 and the outward fixed plate 72 are located correspondingly to the two sides of the long wall 331 or the short wall 332, and the inner fixed plate 71 and the outward fixed plate 72 are fastened to the corresponding long wall 331 or short wall 332 by the corresponding fastening element 73. The inner fixed plate 71 and the outward fixed plate 72 are made of wood, allowing the handle set 70 to be fastened firmly on the long wall 331 or the short wall 332.

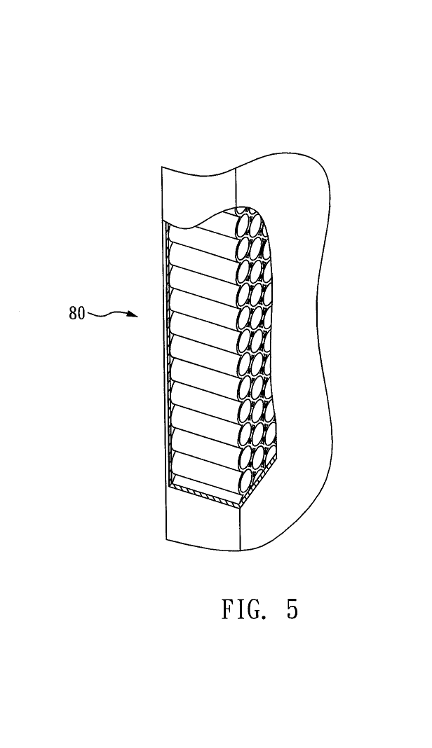

Please refer to FIG. 5, which illustrates a partial cross-sectional drawing of the coffin of the embodiment according to the present invention. One feature of the present invention is that the coffin 1 comprises many elements that are made of cardboard to reduce the cost of materials, allowing the coffin 1 to be lighter and protect environment. As shown in FIG. 5, the preferred material of the abovementioned cardboard is honeycomb cardboard, which can provide sufficient support force and load capacity for containing a human body. However, the material of the cardboard of the present invention is not limited to honeycomb cardboard; the material can be changed to meet requirements to materials such as multi-mounted corrugated board or another similar material.

According to the measuring result of the inventor of the present invention, the load capacity of the coffin 1 of the present invention is over 800 pounds, which is close to or even higher than the load capacity of the coffin of the prior art.

It is noted that the above-mentioned embodiments are only for illustration. It is intended that the present invention cover modifications and variations of this invention provided they fall within the scope of the following claims and their equivalents. Therefore, it will be apparent to those skilled in the art that various modifications and variations can be made to the structure of the present invention without departing from the scope or spirit of the invention.

What is claimed is:

1. A coffin comprising:
a main body comprising:
an upper frame;
a lower frame, wherein the upper frame and the lower frame are made of wood;
a wall comprising:
two long walls made of cardboard;
two short walls, wherein the two long walls and the two short walls are connected to the upper frame and the lower frame, and encircle the upper frame and the lower frame;
a bottom wall positioned on a position of the lower frame, wherein the bottom wall, the two long walls, and the two short walls form a container, and the bottom wall is made of cardboard; and
a first cover positioned above the upper frame, and connected to the main body.

2. The coffin as claimed in claim 1, wherein the upper frame and the lower frame are shaped as a rectangular frame; the long walls, the short walls, and the bottom wall are shaped as rectangles; the bottom wall is bonded to the two long walls and the two short walls, and the bottom wall is further bonded to the lower frame.

3. The coffin as claimed in claim 2, wherein the two short walls are made of cardboard.

4. The coffin as claimed in claim 3, wherein the cardboard is made of honeycomb cardboard.

5. The coffin as claimed in claim 4, wherein the first cover comprises a first outward cover and a first cover frame, and the first cover frame is connected to the first outward cover; the first outward cover further comprises a first main cover and a first side cover, wherein the first main cover is made of cardboard.

6. The coffin as claimed in claim 5, wherein the first cover further comprises a first inclined cover, and the first inclined cover is combined with the first main cover and the first side cover; the first inclined cover and the first side cover are made of cardboard, and the first cover frame is made of wood.

7. The coffin as claimed in claim 6, further comprising two handle sets; the handle sets are respectively positioned on the two long walls, wherein each of the handle sets comprises at least one inner fixed plate, at least one outward fixed plate, at least one fastening element, and at least one handle; the at least one inner fixed plate and the at least one outward fixed plate are positioned correspondingly to two sides of the long wall, and the at least one fastening element fastens the at least one inner fixed plate and the at least one outward fixed plate to the corresponding long wall.

8. The coffin as claimed in claim 7, wherein the at least one inner fixed plate and the at least one outward fixed plate are made of wood.

9. The coffin as claimed in claim 8, wherein the main body further comprises four corner walls; each of the corner walls is positioned between the long wall and the short wall; each of the corner walls is connected to the upper frame and the lower frame; each of the corner wall is made of wood.

10. The coffin as claimed in claim 1, further comprising two handle sets; the handle sets are respectively positioned on the two long walls, wherein each of the handle sets comprises at least one inner fixed plate, at least one outward fixed plate, at least one fastening element, and at least one handle; the at least one inner fixed plate and the at least one outward fixed plate are positioned correspondingly to two sides of the long wall, and the at least one fastening element fastens the at least one inner fixed plate and the at least one outward fixed plate to the corresponding long wall.

11. The coffin as claimed in claim 2, further comprising two handle sets; the handle sets are respectively positioned on the two long walls, wherein each of the handle sets comprises at least one inner fixed plate, at least one outward fixed plate, at least one fastening element, and at least one handle; the at least one inner fixed plate and the at least one outward fixed plate are positioned correspondingly to two sides of the long wall, and the at least one fastening element fastens the at least one inner fixed plate and the at least one outward fixed plate to the corresponding long wall.

12. The coffin as claimed in claim 3, further comprising two handle sets; the handle sets are respectively positioned on the two long walls, wherein each of the handle sets comprises at least one inner fixed plate, at least one outward fixed plate, at least one fastening element, and at least one handle; the at least one inner fixed plate and the at least one outward fixed plate are positioned correspondingly to two sides of the long wall, and the at least one fastening element fastens the at least one inner fixed plate and the at least one outward fixed plate to the corresponding long wall.

13. The coffin as claimed in claim 4, further comprising two handle sets; the handle sets are respectively positioned on the two long walls, wherein each of the handle sets comprises at least one inner fixed plate, at least one outward fixed plate, at least one fastening element, and at least one handle; the at least one inner fixed plate and the at least one outward fixed plate are positioned correspondingly to two sides of the long wall, and the at least one fastening element fastens the at least one inner fixed plate and the at least one outward fixed plate to the corresponding long wall.

14. The coffin as claimed in claim 5, further comprising two handle sets; the handle sets are respectively positioned on the two long walls, wherein each of the handle sets comprises at least one inner fixed plate, at least one outward fixed plate, at least one fastening element, and at least one handle; the at least one inner fixed plate and the at least one outward fixed plate are positioned correspondingly to two sides of the long wall, and the at least one fastening element fastens the at least one inner fixed plate and the at least one outward fixed plate to the corresponding long wall.

15. The coffin as claimed in claim 1, wherein the main body further comprises four corner walls; each of the corner walls is positioned between the long wall and the short wall; each of the corner walls is connected to the upper frame and the lower frame; each of the corner walls is made of wood.

16. The coffin as claimed in claim 2, wherein the main body further comprises four corner walls; each of the corner walls is positioned between the long wall and the short wall; each of the corner walls is connected to the upper frame and the lower frame; each of the corner walls is made of wood.

17. The coffin as claimed in claim 3, wherein the main body further comprises four corner walls; each of the corner walls is positioned between the long wall and the short wall; each of the corner walls is connected to the upper frame and the lower frame; each of the corner walls is made of wood.

18. The coffin as claimed in claim 4, wherein the main body further comprises four corner walls; each of the corner walls is positioned between the long wall and the short wall; each of the corner walls is connected to the upper frame and the lower frame; each of the corner walls is made of wood.

19. The coffin as claimed in claim 5, wherein the main body further comprises four corner walls; each of the corner walls is positioned between the long wall and the short wall; each of the corner walls is connected to the upper frame and the lower frame; each of the corner walls is made of wood.

20. The coffin as claimed in claim 6, wherein the main body further comprises four corner walls; each of the corner walls is positioned between the long wall and the short wall; each of the corner walls is connected to the upper frame and the lower frame; each of the corner walls is made of wood.
